(19) United States
(12) Patent Application Publication
(10) Pub. No.: US 2026/0099893 A1
(43) Pub. Date: Apr. 9, 2026

(54) REUSING BINNING POSITIONS IN RENDERING FOR VERTEX SHADERS

(71) Applicant: QUALCOMM Incorporated, San Diego, CA (US)

(72) Inventors: Xiayang ZHAO, San Diego, CA (US); Jian LIANG, San Diego, CA (US); Minjie HUANG, San Diego, CA (US); Chihong ZHANG, San Diego, CA (US); Yuehai DU, San Diego, CA (US); Junmei SHAO, San Diego, CA (US); Andrew Evan GRUBER, Arlington, MA (US); Tao WANG, Sunnyvale, CA (US); Xuefeng TANG, San Diego, CA (US); Kalyan Kumar BHIRAVABHATLA, Bengaluru (IN); Vishwanath Shashikant NIKAM, Bangalore (IN)

(21) Appl. No.: 18/911,166

(22) Filed: Oct. 9, 2024

(51) Int. Cl. G06T 1/60; G06T 7/73

(52) U.S. Cl. CPC G06T 1/60; G06T 7/75; G06T 2200/04

(57) ABSTRACT

Aspects presented herein relate to methods and devices for graphics processing including an apparatus, e.g., a graphics processor. The apparatus may obtain an indication of a scene including a plurality of primitives, wherein each of the plurality of primitives includes a set of vertices. The apparatus may also determine position data for each vertex in the set of vertices for each of the plurality of primitives. Further, the apparatus store, or refrain from storing, the position data for each vertex in the set of vertices for each of the plurality of primitives based on an execution cycle associated with the position data.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor or display processing unit (DPU).

A graphics processor of a device may be configured to perform the processes in a graphics processing pipeline. Further, graphics processors may be utilized to perform graphics rendering. However, there has developed an increased need for improved rendering in graphics processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processor, a graphics processing unit (GPU), a central processing unit (CPU), or any apparatus that may perform for graphics processing. The apparatus may obtain an indication of a scene including a plurality of primitives, where each of the plurality of primitives includes a set of vertices. The apparatus may also determine position data for each vertex in the set of vertices for each of the plurality of primitives. The apparatus may also obtain an indication to store, or refrain from storing, the position data for each vertex in the set of vertices for each of the plurality of primitives. Additionally, the apparatus may store, or refrain from storing, the position data for each vertex in the set of vertices for each of the plurality of primitives based on an execution cycle associated with the position data. The apparatus may also load, based on storage of the position data for each vertex, the position data for each vertex in the set of vertices for each of the plurality of primitives. Moreover, the apparatus may perform a shading process based on the loaded position data for each vertex in the set of vertices for each of the plurality of primitives. The apparatus may also output an indication of storage, or refrainment from storage, of the position data for each vertex in the set of vertices for each of the plurality of primitives.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example image or surface in accordance with one or more techniques of this disclosure.

FIG. 5 is a diagram illustrating an example culling process in accordance with one or more techniques of this disclosure.

FIG. 6 is a diagram illustrating an example clipping process in accordance with one or more techniques of this disclosure.

FIG. 7 is a diagram illustrating an example primitive clipping operation in accordance with one or more techniques of this disclosure.

FIG. 8 is a diagram illustrating an example rendering process in accordance with one or more techniques of this disclosure.

FIG. 9 is a diagram illustrating an example position data storage process in accordance with one or more techniques of this disclosure.

FIG. 10 is a diagram illustrating an example position data storage process in accordance with one or more techniques of this disclosure.

FIG. 11 is a diagram illustrating an example position data storage process in accordance with one or more techniques of this disclosure.

FIG. 12 is a diagram illustrating an example position data storage process in accordance with one or more techniques of this disclosure.

FIG. 13 is a communication flow diagram illustrating example communications between a GPU, a CPU, and a memory in accordance with one or more techniques of this disclosure.

FIG. 14 is a flowchart of an example method of graphics processing in accordance with one or more techniques of this disclosure.

FIG. 15 is a flowchart of an example method of graphics processing in accordance with one or more techniques of this disclosure.

### DETAILED DESCRIPTION

Some aspects of graphics processing may use a number of different modes for rendering. For example, GPUs may use a binning mode or a direct mode for rendering a scene or frame. In binning mode or binning rendering mode, at least one image or frame of a scene (e.g., a two-dimensional (2D) or three-dimensional (3D) scene) may be rendered by dividing the image or frame into smaller parts (e.g., bins or tiles). Each of these bins or tiles may then be rendered separately. Binning mode or binning rendering mode may be useful for applications where little dedicated memory (e.g., graphics memory (GMEM)) is available (e.g., in mobile applications). The size of the bins or tiles may be configured to represent the amount of data that is available in the memory (e.g., GMEM). For example, if the GMEM is able to store a certain amount of data (e.g., 512 kB), the size of a bin or tile may be configured so that that pixel data contained in that bin or tile is less than or equal to the amount of data (e.g., 512 kB). In direct rendering mode, an image or frame may not be divided into smaller bins or tiles. Rather, the entire image or frame may be rendered at one time. In some graphics processing systems (e.g., a graphics processing system on a mobile device), there may not be enough memory (e.g., GMEM) to store an entire image or frame of pixel data. As such, in a direct rendering mode, different types of memory (e.g., system memory) may be used to render the image or frame. Some GPUs may perform a large number of calculations during a rendering operation. For instance, GPUs may perform a number of calculations for position data for an image or frame when rendering a scene. That is, when rendering a scene, GPUs may need to calculate position data for an image or frame a number of different times. For example, position data may need to be calculated, and the stored, and then re-calculated at a later time. These multiple calculations of position data may utilize a large amount of processing at the GPU, as well as a large amount of power at the GPU. Aspects of the present disclosure may be able to avoid multiple calculations of position data.

Aspects of the present disclosure may include a number of benefits or advantages. For instance, aspects of the present disclosure may avoid multiple calculations of position data. That is, aspects presented herein may reduce the amount of calculation operations during a rendering operation or a shading operation. For example, aspects presented herein may reduce the amount of calculation operations for position data during a rendering operation or a shading operation. For instance, aspects presented herein may avoid unnecessary calculations of position data during a rendering operation or a shading operation for a scene. Indeed, aspects presented herein may reduce the amount of processing performed at a GPU during rendering operations or shading operations. Also, aspects presented herein may reduce the amount of processing performed at a GPU when calculating position data for rendering operations or shading operations. Aspects presented herein may also reduce the amount of power utilized at the GPU during rendering operations or shading operations. Further, aspects presented herein may reduce the amount of power utilized at a GPU when calculating position data for rendering operations or shading operations. Based on this, aspects presented herein may optimized the processing and/or power utilization at a GPU.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended. In some examples, as used herein, the term “graphics workload” may refer to any workload or order associated with graphics processing. In some examples, as used herein, the term “texture fetch” may refer to a memory request, which incurs transactions from a cache (e.g., a texture cache). Each time a warp executes a texture function to read from texture memory, this may be a single texture fetch. Also, texture memory may be read-only device memory, and may be accessed using the device functions described in a texture function. Reading a texture using one of these functions may be called a “texture fetch.” A “render target” may refer to a target block of pixels (buffer) into which rendering will occur. In some aspects, a render target may refer to a buffer where the pixels are drawn (e.g., a video card draws pixels) for a scene that is being rendered in the background. An intermediate render target may refer to a render target that is used in post-processing.

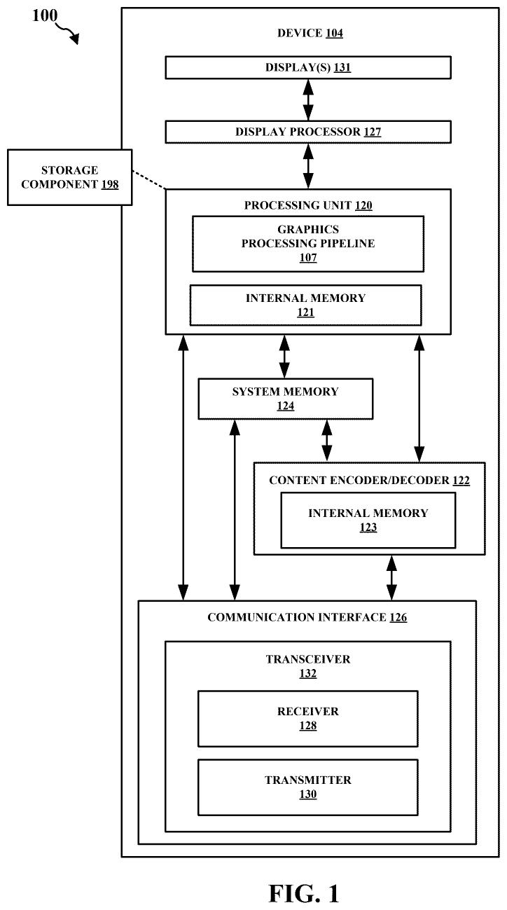

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a storage component 198 configured to obtain an indication of a scene including a plurality of primitives, where each of the plurality of primitives includes a set of vertices. The storage component 198 may also be configured to determine position data for each vertex in the set of vertices for each of the plurality of primitives. The storage component 198 may also be configured to obtain an indication to store, or refrain from storing, the position data for each vertex in the set of vertices for each of the plurality of primitives. The storage component 198 may also be configured to store, or refrain from storing, the position data for each vertex in the set of vertices for each of the plurality of primitives based on an execution cycle associated with the position data. The storage component 198 may also be configured to load, based on storage of the position data for each vertex, the position data for each vertex in the set of vertices for each of the plurality of primitives. The storage component 198 may also be configured to perform a shading process based on the loaded position data for each vertex in the set of vertices for each of the plurality of primitives. The storage component 198 may also be configured to output an indication of storage, or refrainment from storage, of the position data for each vertex in the set of vertices for each of the plurality of primitives. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

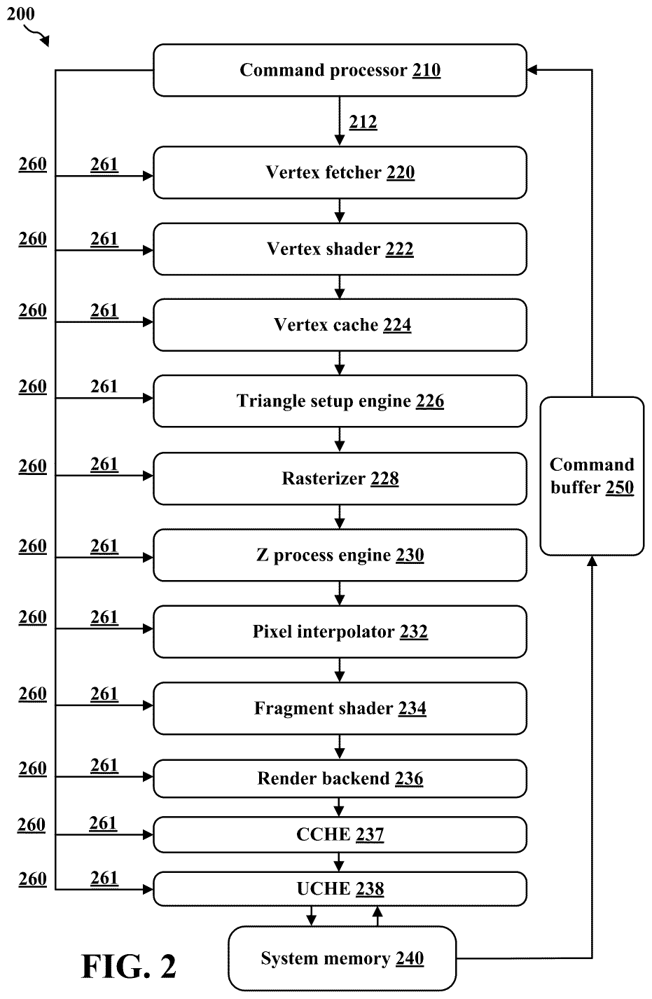

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in double data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

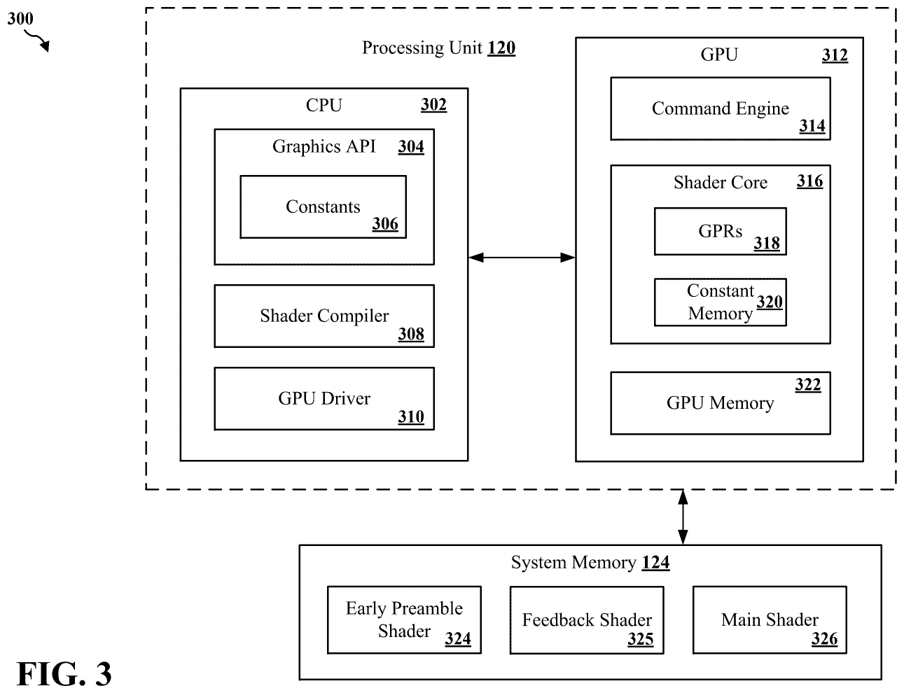

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

GPUs can render images in a variety of different ways. In some instances, GPUs can render an image using rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. In some aspects, during the binning pass, a visibility stream can be constructed where visible primitives or draw calls can be identified. In contrast to tiled rendering, direct rendering does not divide the frame into smaller bins or tiles. Rather, in direct rendering, the entire frame is rendered at a single time. Additionally, some types of GPUs can allow for both tiled rendering and direct rendering.

In some aspects, GPUs can apply the drawing or rendering process to different bins or tiles. For instance, a GPU can render to one bin, and perform all the draws for the primitives or pixels in the bin. During the process of rendering to a bin, the render targets can be located in the GMEM. In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory used to drop primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

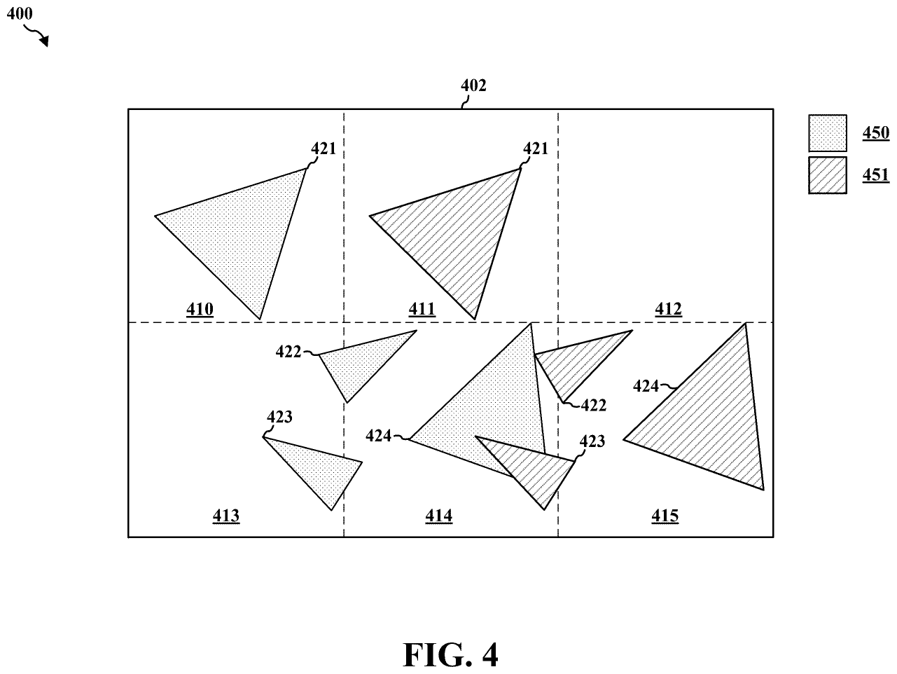

FIG. 4 illustrates image or surface 400, including multiple primitives divided into multiple bins. As shown in FIG. 4, image or surface 400 includes area 402, which includes primitives 421, 422, 423, and 424. The primitives 421, 422, 423, and 424 are divided or placed into different bins, e.g., bins 410, 411, 412, 413, 414, and 415. FIG. 4 illustrates an example of tiled rendering using multiple viewpoints for the primitives 421-424. For instance, primitives 421-424 are in first viewpoint 450 and second viewpoint 451. As such, the GPU processing or rendering the image or surface 400 including area 402 can utilize multiple viewpoints or multi-view rendering.

As indicated herein, GPUs or graphics processor units may use a tiled rendering architecture to reduce power consumption or save memory bandwidth. As further stated above, this rendering method may divide the scene into multiple bins, as well as include a visibility pass that identifies the triangles that are visible in each bin. Thus, in tiled rendering, a full screen may be divided into multiple bins or tiles. The scene may then be rendered multiple times, e.g., one or more times for each bin. In aspects of graphics rendering, some graphics applications may render to a single target, i.e., a render target, one or more times. For instance, in graphics rendering, a frame buffer on a system memory may be updated multiple times. The frame buffer may be a portion of memory or random access memory (RAM), e.g., containing a bitmap or storage, to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

In some aspects of graphics processing, rendering may be performed in multiple locations and/or on multiple devices, e.g., in order to divide the rendering workload between different devices. For example, the rendering may be split between a server and a client device, which may be referred to as “split rendering.” In some instances, split rendering may be a method for bringing content to user devices or head mounted displays (HMDs), where a portion of the graphics processing may be performed outside of the device or HMD, e.g., at a server. Split rendering may be performed for a number of different types of applications, e.g., virtual reality (VR) applications, augmented reality (AR) applications, and/or extended reality (XR) applications. In VR applications, the content displayed at the user device may correspond to man-made or animated content, e.g., content rendered at a server or user device. In AR or XR content, a portion of the content displayed at the user device may correspond to real-world content, e.g., objects in the real world, and a portion of the content may be man-made or animated content. Also, the man-made or animated content and real-world content may be displayed in an optical see-through or a video see-through device, such that the user may view real-world objects and man-made or animated content simultaneously. In some aspects, man-made or animated content may be referred to as augmented content, or vice versa.

In certain types of graphics processing, e.g., augmented reality (AR) applications, virtual reality (VR) applications, or three-dimensional (3D) games, objects may occlude (i.e., obscure, cover, block, or obstruct) other objects from the vantage point of the user device. There may also be different types of occlusions within AR/VR applications or 3D games. For example, augmented content may occlude real-world content, e.g., a rendered object may partially occlude a real object. Also, real-world content may occlude augmented content, e.g., a real object may partially occlude a rendered object. This overlap of real-world content and augmented content, which produces the aforementioned occlusions, is one reason that augmented content and real-world content may blend so seamlessly within AR. This may also result in augmented content and real-world content occlusions being difficult to resolve, such that the edges of augmented and real-world content may incorrectly overlap.

In some aspects, augmented content or augmentations may be rendered over real-world or see-through content. As such, augmentations may occlude whatever object is behind the augmentation from the vantage point of the user device. For example, pixels without an occlusion material, i.e., a red (R), green (G), blue (B) (RGB) value not equal to (0,0,0), may be rendered to occlude real-world objects. Accordingly, an augmentation with a certain value (e.g., a non-zero value) may occlude real-world objects behind the augmentation. In video see-through systems, the same effect may be achieved by compositing the augmentation layer to the foreground. As such, augmentations may occlude rendered content or real-world content, or vice versa. As indicated above, when utilizing VR/AR systems or 3D games, capturing occlusions accurately may be a challenge. Moreover, this may be especially true for VR/AR systems or 3D games with latency issues. In some aspects, it may be especially difficult to accurately capture augmented content that is occluding other augmented content, or accurately capture a real-world object that is occluding augmented content. An accurate occlusion of augmented content or real-world content and the occluded augmented content may help a user to obtain a more realistic and immersive VR/AR or 3D game experience.

Some aspects of graphics processing, may utilize occlusion culling, which is a feature that disables the rendering of objects when they are not currently seen by a camera because they are obscured (i.e., occluded) by other objects. For instance, occlusion culling may remove objects in a scene from the camera rendering workload if the objects are entirely obscured by objects closer to the camera. In some aspects, the occlusion culling process may pass through the scene using a virtual camera to build a hierarchy of potentially visible sets of objects. This data may be used by each camera in the graphics processing application to identify which objects are visible or not visible. Occlusion culling may increase rendering performance (e.g., GPU rendering performance) simply by not rendering objects that are outside the viewing area of the camera, or objects that are hidden by other objects closer to the camera. In one instance, the occlusion culling process may be defined as follows: for a camera view in a scene, given a set of occluders (i.e., objects that are occluding other objects) and a set of occludees (i.e., objects that are being occluded by other objects), the visibility of the occludees may be derived or determined based on the relative location of the occluders. For example, if a wall in a scene is closer to the camera than a set of barrels behind the wall, and there are holes in the wall, the occlusion culling process may determine which barrels are visible through the holes in the wall.

Some types of occlusion culling in graphics processing (e.g., occlusion culling for CPUs or GPUs) may include software occlusion culling. For example, in software occlusion culling, for each occluder and each primitive/triangle in a scene, the primitive/triangle may be rasterized to generate an occluder depth map. Also, for each occluder in the scene, the projected axis-aligned bounding box (AABB) area in the occluder depth map may be determined, as well as the nearest depth value of the occludee. Additionally, the occludee's nearest depth value in the projected AABB region may be determined on the occluder depth map. The occludee may be determined to be visible if its nearest depth value is larger than all depth values inside the AABB area. Otherwise, if the occludee's nearest depth value is not larger than all depth values inside the AABB area, the occludee may be determined to be invisible.

Additionally, there are other types of occlusion culling utilized in graphics processing (e.g., occlusion culling in CPUs or GPUs). For instance, there are types of software occlusion culling utilizing CPU single instruction multiple data (SIMD) components. This SIMD-optimized occlusion culling may correspond to an optimized version of an open-source project. This type of occlusion culling may render depth maps (e.g., an occluder depth map) more accurately and faster (e.g., 2-16 times faster) compared to other types of occlusion culling. SIMD-optimized occlusion culling may also be more accurate compared to GPU hardware occlusion culling (HWOC). For example, mobile chip occlusion culling may achieve zero frame latency throughout the rendering process, while GPU hardware occlusion culling may cause latency issues for at least one frame throughout the rendering process. Additionally, SIMD-optimized occlusion culling may result in a smaller draw call amount compared to other types of occlusion culling.

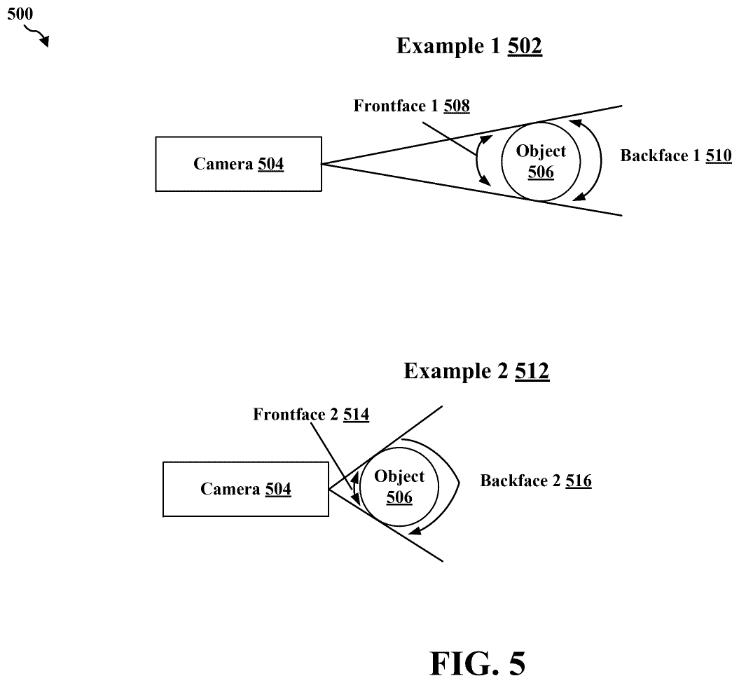

FIG. 5 is a diagram 500 illustrating example aspects of a culling process. A back of a solid, opaque object may be hidden from a direct line of sight from an observer. As such, when a scene is rendered on a display, the observer may not be able to see the back of the solid, opaque object. An apparatus (e.g., a GPU) may cull (i.e., remove) primitives (e.g., triangles) associated with the back of the solid, opaque object in order to reduce an amount of scene geometry that is rendered. The aforementioned culling may be referred to as “culling” or “backface culling.” Reducing the amount of scene geometry that is rendered may reduce an amount of computations performed by the apparatus.

As shown in FIG. 5, in a first example 502, a lens of a camera 504 may face an object 506. The object 506 may be solid and opaque. A portion of the object 506 that is visible to the camera 504 may be referred to as a frontface of the object 506 (referred to now as “a first frontface 508”). A portion of the object 506 that is not visible to the camera 504 may be referred to as a backface of the object 506 (referred to now as “a first backface 510”). In the first example 502, the camera 504 may be located relatively far away from the object 506 and hence the first backface 510 may be around 50% of a surface of the object 506. An apparatus may perform backface culling on primitives associated with the first backface 510 in order to reduce the amount of scene geometry rendered.

As further shown in FIG. 5, in a second example 512, the lens of the camera 504 may face the object 506 as in the first example 502. However, in the second example 512, the object 506 may be located relatively closer to the camera 504 in comparison to a location of the object 506 and the camera 504 in the first example 502. The object 506 may have a second frontface 514 and a second backface 516. As the object 506 is located closer to the lens of the camera 504 compared to the location of the object 506 and the camera 504 in the first example 502, the second backface 516 may be relatively large. For instance, the second backface 516 may be greater than 50% of the surface of the object 506. An apparatus may perform backface culling on primitives associated with the second backface 516 in order to reduce the amount of scene geometry rendered.

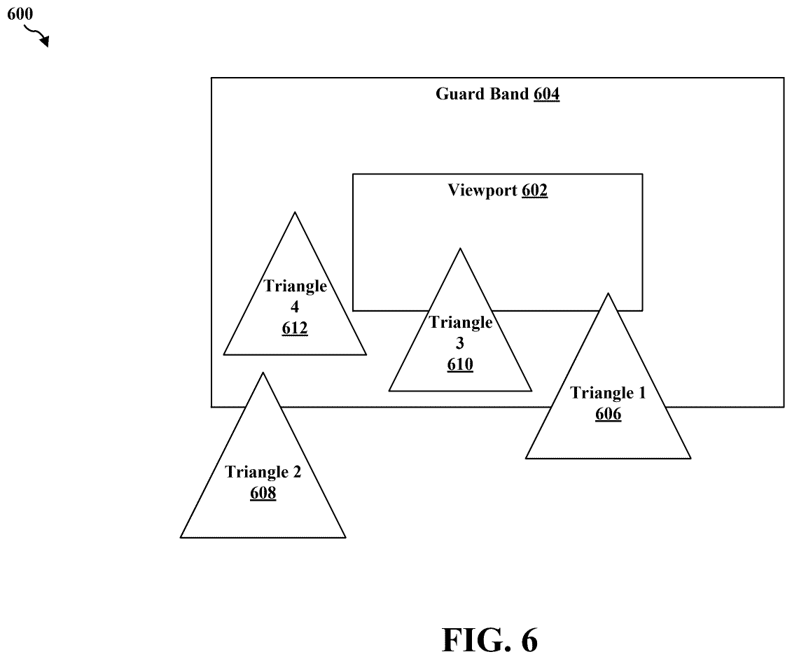

FIG. 6 is a diagram 600 illustrating example aspects of clipping, such as guard band clipping. “Guard band clipping” may refer to a technique used by an apparatus (e.g., a GPU) to reduce an amount of clipping performed. In guard band clipping, a primitive may be clipped if the primitive extends beyond a guard band, where the guard band is associated with a first region that is larger than a second region associated with a viewport and that encompasses the viewport. In an example, the first region associated with the guard band may be orders of magnitude greater than the second region associated with the viewport. In non-guard band clipping, a primitive may be clipped if the primitive extends beyond the viewport. As used herein, the term “clipping” or “clipping operation” may refer to removing a portion of a primitive (e.g., a triangle) from a rendering process. Guard band clipping may enable the apparatus to accept primitives that are partially or completely off-screen.

As shown in FIG. 6, the diagram 600 depicts a viewport 602 and a guard band 604. In an example, the viewport 602 may be associated with a first area and the guard band 604 may be associated with a second area, where the first area is smaller than the second area. The viewport 602 may be located within the guard band 604. In an example, the viewport 602 may be associated with a resolution of 1920 pixels by 1080 pixels. In an example, a first triangle 606 may include a first portion located in the viewport 602, a second portion located outside of the viewport 602 and within the guard band 604, and a third portion located outside of the guard band 604. In an example, the first triangle 606 may be defined by floating point coordinates (described in greater detail below). An apparatus (e.g., a GPU) may clip the second portion and the third portion as the first triangle 606 extends beyond the guard band 604. Alternatively, the apparatus may clip the third portion. After clipping, the first triangle 606 may be represented by fixed point coordinates (described in greater detail below).

As depicted in FIG. 6, in another example, a second triangle 608 may include a first portion that is within the guard band 604 and a second portion that is outside of the guard band 604. The apparatus may remove the second triangle 608 from a rendering process as the second triangle 608 does not intersect the viewport 602. When removed from the rendering process, the second triangle 608 may not have to undergo clipping and hence computational costs may be reduced. Alternatively, the apparatus may clip the second portion of the second triangle 608. In yet another example, a third triangle 610 may include a first portion that is within the viewport 602 and a second portion that is within the guard band 604. As the third triangle 610 does not extend beyond the guard band 604, the apparatus may accept the third triangle 610 and the apparatus may avoid performing clipping on the third triangle 610. In a further example, a fourth triangle 612 may be within the guard band 604 and the fourth triangle 612 may not intersect the viewport 602. The apparatus may remove the fourth triangle 612 from a rendering process as the fourth triangle 612 does not intersect the viewport 602. When removed from the rendering process, the fourth triangle 612 may not have to undergo clipping and hence computational costs may be reduced.

In some aspects, prior to a clipping operation, a graphics processor or GPU may perform primitive assembly, which is the process of grouping of vertices into lines and triangles. Once primitives have been constructed from their individual vertices, they may be clipped against a displayable region (i.e., the window or screen), which may also be a smaller area known as the viewport. The portions of the primitive that are determined to be potentially visible may be sent to a rasterizer or rasterization block. The rasterization block may determine which pixels are covered by the primitive (e.g., a point, line, or triangle) and then sends the list of pixels to a next stage in the pipeline (e.g., fragment shading).

In some aspects of graphics processing, clipping may be performed to selectively enable or disable rendering operations within a certain range of interest (e.g., a viewing frustum). The “view frustum” or “viewing frustum” may be the region of space in a modeled world that may appear on the screen; such as the field of view of a perspective virtual camera system. For example, a box surrounding a viewing plane and virtual space may represent the viewing frustum or view frustum. For instance, rendering may be performed on pixels at the intersection between the defined clipping area and the scene, while pixels/areas outside of the visible area (e.g., viewing frustum) may be removed from the rendering calculation. As the clipping process may reduce the amount of rendering performed (e.g., rendering at a GPU), clipping may help to improve rendering performance (e.g., at a GPU). Further, a clipping process that is well-defined may allow the rendering component (e.g., a GPU) to reduce processing time and energy by skipping rendering calculations that fall outside of the visible area (e.g., viewing frustum). In some instances, clipping may occur in a Cartesian space (i.e., with Cartesian coordinates).

Additionally, in some aspects of graphics processing (e.g., three-dimensional (3D) graphics), clipping and culling may be used to describe many related features. For example, “clipping” may refer to operations in the plane that work with certain shapes (e.g., rectangular shapes), while “culling” may refer to more general methods of selectively processing elements within a scene model. In some instances, elements of a scene model may include certain geometric primitives (e.g., points/nodes, line segments/edges, polygons/faces). A “primitive” may refer to a graphics object that is utilized for the creation or construction of complex images, such as a shape (e.g., a triangle). In some types of scene models, individual elements can be deactivated (truncated) for reasons of visibility within the viewport or viewing section (e.g., backface culling, occlusion culling, depth clipping or Z-clipping, etc.). There may be different types of algorithms performed at a GPU in order to detect and perform such clipping operations. Further, in some aspects, clipping may be performed by determining which side of each of a plane (e.g., a plane in the viewing frustum) the vertices of each primitive lie. For example, if a primitive's vertices are all on the “outside” of any one plane (e.g., a plane in the viewing frustum), then the entire primitive may be discarded. If all of primitive's vertices are all on the “inside” of all the planes (and thus entirely inside the viewing frustum or view volume), then the primitive may be passed through unaltered. Primitives that are partially visible (i.e., they cross one of the planes in the viewing frustum) may be handled on an individual basis according to the functionality of the GPU.

In depth clipping or Z-clipping (or Z clipping), the “Z” direction may refer to the depth axis in the coordinate system, which is centered on a viewport origin within the viewing frustum. For instance, the “Z” direction may be used interchangeably with “depth” and may correspond to the distance “into the virtual screen” from the viewport origin. Also, in this coordinate system, “X” and “Y” may refer to a conventional Cartesian coordinate system located on the user's screen or the viewport. In some instances, the viewport may also be defined by the geometry of the field of view (FoV). Additionally, Z-clipping or depth clipping may refer to techniques for selectively rendering certain scene objects based on their depth (or Z-axis) relative to the screen. Further, a near clipping depth and a far clipping depth may be specified relative to the screen, such that the portions of objects between these two specified depths may be displayed.

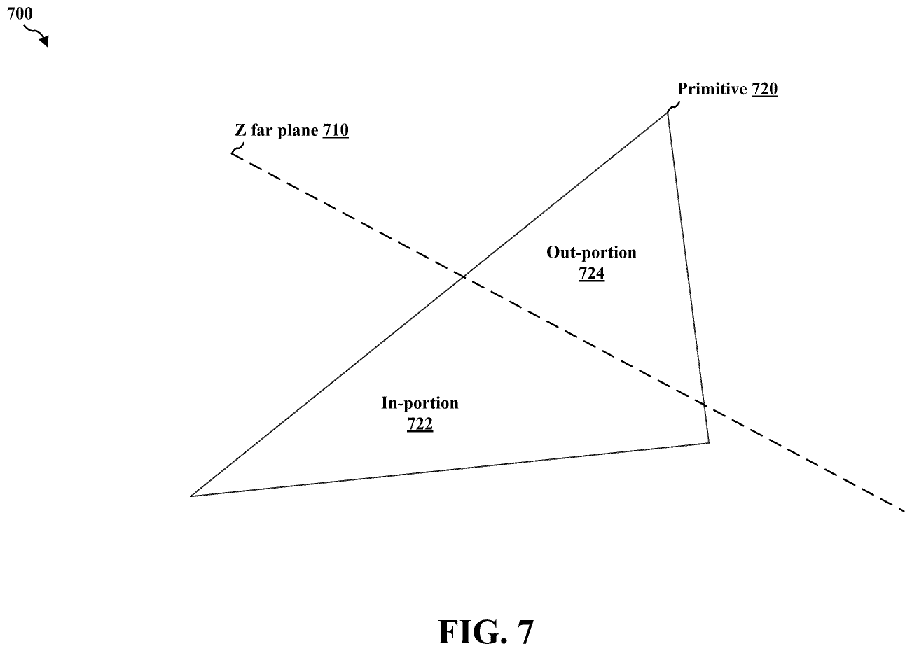

FIG. 7 is a diagram 700 illustrating an example primitive clipping operation. More specifically, diagram 700 depicts a clipping operation performed on a primitive in a Z-direction (i.e., Z clipping). As shown in FIG. 7, diagram 700 includes Z far plane 710 and primitive 720 including in-portion 722 and out-portion 724. FIG. 7 depicts that primitive 720 is divided in the Z direction by Z far plane 710, which produces in-portion 722 (i.e., the portion of primitive 720 that is within the viewing frustum) and out-portion 724 (i.e., the portion of primitive 720 that is outside of the viewing frustum). For instance, in-portion 722 depicts the primitive portion and vertices of primitive 720 that are within the Z far plane 710 (e.g., a plane in a Z direction in the viewing frustum). Likewise, out-portion 724 depicts the primitive portion and vertices of primitive 720 that are outside of the Z far plane 710 (e.g., a plane in a Z direction in the viewing frustum). As indicated herein, if a primitive's vertices (e.g., vertices of primitive 720) are all outside of any one plane (e.g., Z far plane 710), then the entire primitive may be discarded. Further, if all of primitive's vertices (e.g., vertices of primitive 720) are within all the planes (e.g., Z far plane 710 thus entirely inside the viewing frustum or view volume), then the primitive may be passed through unaltered. As shown in FIG. 7, primitives that are partially visible (i.e., they are bisected by Z far plane), such as primitive 720, may be handled on an individual basis. For example, the vertices or pixels corresponding to in-portion 722 of primitive 720 may be retained, while the vertices or pixels corresponding to out-portion 724 of primitive 720 may be discarded.

Some aspects of graphics processing may use a number of different modes for rendering. For example, GPUs may use a binning mode or a direct mode for rendering a scene or frame. In binning mode or binning rendering mode, at least one image or frame of a scene (e.g., a two-dimensional (2D) or three-dimensional (3D) scene) may be rendered by dividing the image or frame into smaller parts (e.g., bins or tiles). Each of these bins or tiles may then be rendered separately. Binning mode or binning rendering mode may be useful for applications where little dedicated memory (e.g., graphics memory (GMEM)) is available (e.g., in mobile applications). The size of the bins or tiles may be configured to represent the amount of data that is available in the memory (e.g., GMEM). For example, if the GMEM is able to store a certain amount of data (e.g., 512 kB), the size of a bin or tile may be configured so that that pixel data contained in that bin or tile is less than or equal to the amount of data (e.g., 512 kB). In direct rendering mode, an image or frame may not be divided into smaller bins or tiles. Rather, the entire image or frame may be rendered at one time. In some graphics processing systems (e.g., a graphics processing system on a mobile device), there may not be enough memory (e.g., GMEM) to store an entire image or frame of pixel data. As such, in a direct rendering mode, different types of memory (e.g., system memory) may be used to render the image or frame.

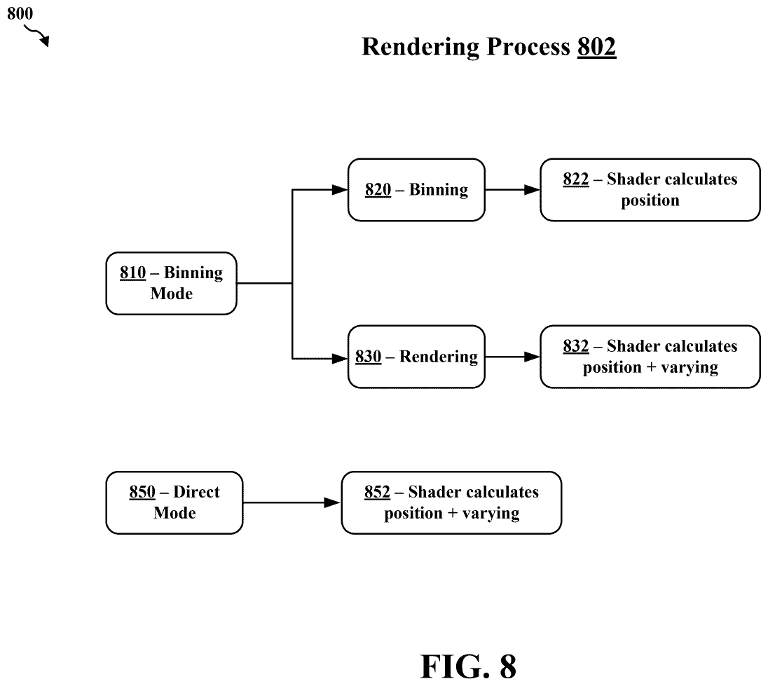

FIG. 8 illustrates diagram 800 including one example of a rendering process. More specifically, diagram 800 depicts an example rendering process 802 at a GPU. As shown in FIG. 8, at 810, the GPU may perform a binning mode or a binning rendering mode. For example, the GPU may select a binning mode for a rendering operation. At 820, during the binning mode, the GPU may perform a binning operation. At 822, the GPU may utilize a shader to calculate a position or position data. At 830, during the binning mode, the GPU may perform a rendering operation. At 832, the GPU may utilize a shader to calculate a position or position data, as well as varying data. As shown in FIG. 8, at 850, the GPU may perform a direct mode or a direct rendering mode. For example, the GPU may select a direct mode for a rendering operation. At 852, during the direct mode, the GPU may utilize a shader to calculate a position or position data, as well as varying data.

Some GPUs may perform a large number of calculations during a rendering operation. For instance, GPUs may perform a number of calculations for position data for an image or frame when rendering a scene. That is, when rendering a scene, GPUs may need to calculate position data for an image or frame a number of different times. For example, position data may need to be calculated, and the stored, and then re-calculated at a later time. These multiple calculations of position data may utilize a large amount of processing at the GPU, as well as a large amount of power at the GPU. Based on the above, it may be beneficial for a GPU to be able to avoid multiple calculations of position data. That is, it may be beneficial for a GPU to avoid unnecessary calculations of position data during a rendering operation for a scene. In turn, it may be beneficial to reduce the amount of processing performed at a GPU when calculating position data. Also, it may be beneficial to reduce the amount of power utilized at the GPU when calculating position data.

Aspects of the present disclosure may be able to avoid multiple calculations of position data. That is, aspects presented herein may reduce the amount of calculation operations during a rendering operation or a shading operation. For example, aspects presented herein may reduce the amount of calculation operations for position data during a rendering operation or a shading operation. For instance, aspects presented herein may avoid unnecessary calculations of position data during a rendering operation or a shading operation for a scene. Indeed, aspects presented herein may reduce the amount of processing performed at a GPU during rendering operations or shading operations. Also, aspects presented herein may reduce the amount of processing performed at a GPU when calculating position data for rendering operations or shading operations. Aspects presented herein may also reduce the amount of power utilized at the GPU during rendering operations or shading operations. Further, aspects presented herein may reduce the amount of power utilized at a GPU when calculating position data for rendering operations or shading operations. Based on this, aspects presented herein may optimized the processing and/or power utilization at a GPU.

Aspects presented herein may obtain an indication of a scene including a plurality of primitives, where each of the plurality of primitives includes a set of vertices. That is, a GPU may receive, from a graphics driver at a CPU, an indication of a scene including a plurality of primitives, where each of the plurality of primitives includes a set of vertices. Aspects presented herein may also determine or calculate position data for each vertex in the set of vertices for each of the plurality of primitives. Additionally, aspects presented herein may store, or refrain from storing, the position data for each vertex in the set of vertices for each of the plurality of primitives based on an execution cycle associated with the position data. Based on the execution cycle, if the position data for each vertex is stored, aspects presented herein may load the position data for each vertex in the set of vertices for each of the plurality of primitives. That is, based on storing the position data for each vertex, a GPU may load the position data for each vertex for each of the plurality of primitives. By loading the position data after the storage, GPUs may avoid multiple calculations or re-calculating the position data. Accordingly, aspects presented herein may help to optimize the processing and/or power utilization at a GPU. GPUs may also perform, during a rendering stage, a shading process based on the loaded position data for each vertex in the set of vertices for each of the plurality of primitives.

In some instances, GPUs may stream out certain data (e.g., vertex data) into memory (e.g., system memory) in order to save on shading (e.g., shading at a vertex shader (VS)) during rendering. Aspects presented herein may allow GPUs to store position data (e.g., VS position data) into certain memory (e.g., a GMEM). Also, aspects presented herein may read back this position data during rendering. By doing so, aspects presented herein may reduce the amount of VS position shading during rendering. For example, aspects presented herein may allow a shader at a GPU to reduce the amount of VS position shading during rendering. Further, aspects presented herein may reduce the amount of memory read and/or latency if there is a texture fetch in the vertex shader (VS). Aspects presented herein may also reduce the amount of position loading when rendering. That is, aspects presented herein may reuse a binning position during rendering at a vertex shader (VS).

Aspects presented herein may utilize a number of different aspects of a GPU in order to reuse a binning position during rendering. For instance, aspects presented herein may utilize GPU software and GPU hardware to reuse a binning position during rendering. When utilizing GPU software, a compiler at a GPU may use a certain function (e.g., a storage or “stg” function) to store position data into memory (e.g., GMEM). During rendering at a vertex shader (VS), the compiler may use another function (e.g., a load or “ldg” function) to read back the position data. By using the load or “ldg” function to read back the position data, the compiler may reduce the amount of position loading and/or reuse a binning position during rendering. This may allow the GPU to avoid multiple calculations of the position data and optimize the processing and/or power utilization at the GPU. Aspects presented herein may also utilize a selective store position into memory (e.g., GMEM). For instance, during a VS heavy draw, if the VS execution cycle>N (e.g., N=200 or N=1000) cycles, aspects presented herein may utilize a selective store position into memory (e.g., GMEM). Also, if there is a texture fetch at the VS, aspects presented herein may utilize a selective store position into memory (e.g., GMEM). When utilizing GPU hardware, aspects presented herein may utilize a hardware store position into memory (e.g., GMEM). That is, aspects presented herein may utilize a hardware store position into GMEM (may defer to low-resolution Z (LRZ)) and a read back position (e.g., a VPC read back position) from GMEM when rendering.

By reusing a binning position during rendering, aspects presented herein may achieve a number of performance benefits. For instance, by avoid multiple calculations of the position data and optimize the processing and/or power utilization at a GPU, aspects presented herein may allow GPUS to reduce the amount of memory read traffic. For example, aspects presented herein may reduce a certain amount of memory read traffic (e.g., save around 1 MB memory read traffic). This may correspond to reducing a certain amount of frame level read traffic (e.g., reduce 1.2% frame level read traffic). Some types of applications may utilize a heavy VS shader and a texture fetch operation. Aspects presented herein may work well with these types of application by reusing a binning position during rendering.

Aspects presented herein may utilize different types of storage operations. For instance, aspects presented herein may utilize a selective store operation and/or an all store operation. For a certain profile and/or performance gain, aspects presented herein may use an all store operation for certain memories or GMEM (e.g., an 18 MB GMEM). When utilizing a selective store operation, aspects presented herein may allocate a limit at a GMEM (e.g., persistent GMEM (pGMEM)) in order to obtain a good uplift in performance. For example, a portion of a GMEM may be allocated for storing vertex data. If the GMEM (e.g., pGMEM) is full, aspects presented herein may just store heavy VS position data into the GMEM (e.g., pGMEM). If it the GMEM (e.g., pGMEM). is still full, aspects presented herein may ignore the remaining vertex position data. Also, the compiler at the GPU may stop storing position data. Aspects presented herein may also force a split surface into a sub-surface and kick off it. However, aspects presented herein may need a certain buffer (e.g., a pingpong buffer) in GMEM (e.g., pGMEM) in order to ensure concurrency for the next sub-surface. Aspects presented herein may also fetch position data in rendering due to a vertex buffer layout and a certain fetch granularity (e.g., a VFD fetch granularity or 256b). Further, aspects presented herein may over fetch during rendering in order to fetch vertex position during rendering.

Additionally, aspects presented herein may store both position data and/or varying data in GMEM (e.g., pGMEM). Also, aspects presented herein may full skip rendering for the VS (i.e., it may still need to load). Aspects presented herein may also utilize a GMEM (e.g., pGMEM) allocation tradeoff (e.g., a tradeoff between a VS output data and a render target (RT)). Moreover, aspects presented herein may utilize a hardware store position into a GMEM process. During binning, aspects presented herein may utilize a VS output to a VPC. After a TSE kill, aspects presented herein may utilize VPC store and survive vertex into GMEM (e.g., pGMEM). After a low-resolution Z (LRZ), the VPC may kill invisible primitives from GMEM (e.g., pGMEM). Further, aspects presented herein may mark the GMEM (e.g., pGMEM) address as invalid. During rendering, the VPC may read back position data from the GMEM.

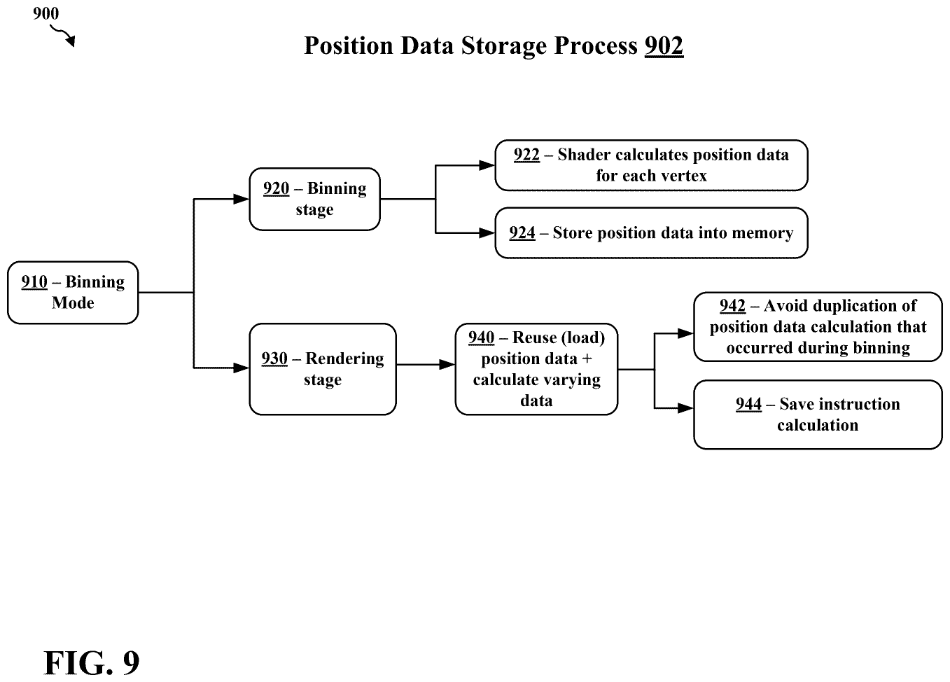

FIG. 9 illustrates diagram 900 including one example of a position data storage process. More specifically, diagram 900 depicts position data storage process 902 for a binning mode. As shown in FIG. 9, at 910, a GPU may operate in a binning mode. At 920, the GPU may operate in a binning stage of the binning mode. At 922, the GPU may utilize a shader to calculate the position data for each vertex. At 924, the GPU may store the position data into memory (e.g., a GMEM). Additionally, at 930, the GPU may operate in a rendering stage of the binning mode. At 940, the GPU may reuse (or load) position data and/or calculate varying data. At 942, the GPU may avoid a duplication of position data calculation that occurred during the binning stage. At 944, by doing so, the GPU may reduce or save the instruction calculation. That is, by reusing (or loading) position data that occurred during the binning stage, the GPU may avoid duplicate or multiple calculations of position data that occurred during the binning stage. This may allow the GPU to avoid multiple calculations of the position data and optimize the processing and/or power utilization at the GPU.

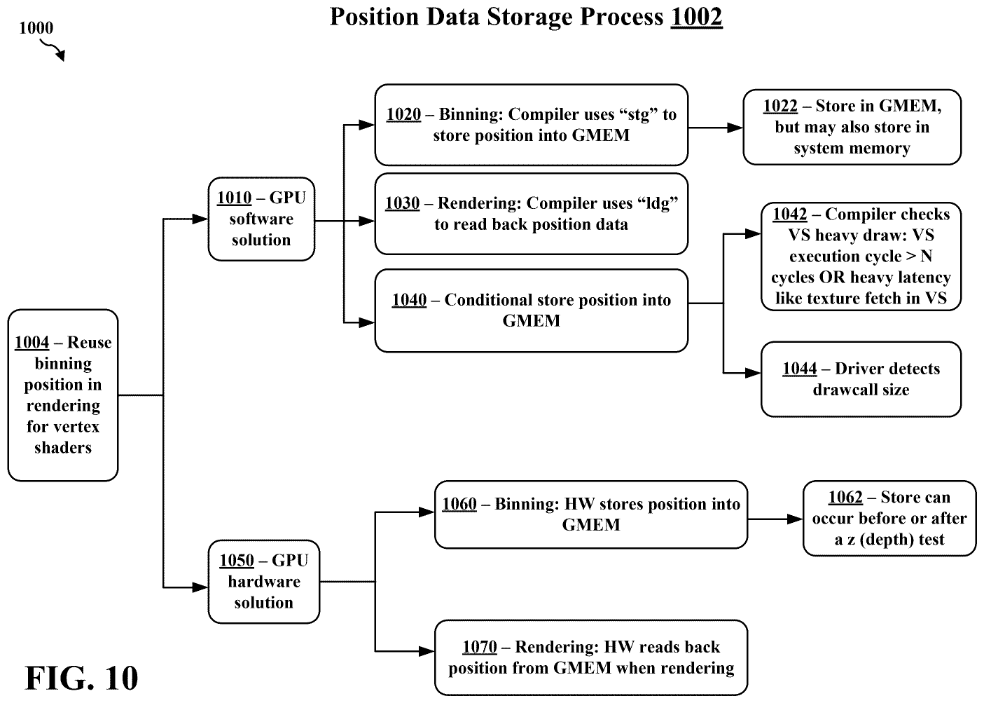

FIG. 10 illustrates diagram 1000 including one example of a position data storage process. More specifically, diagram 1000 depicts position data storage process 1002 for binning and/or rendering. As shown in FIG. 10, at 1004, a GPU may reuse a binning position during rendering for vertex shaders. At 1010, a GPU may utilize a software solution. At 1020, during binning, a compiler may utilize a storage or “stg” function to store position data into a GMEM. At 1022, the GPU may store position data in a GMEM, but it may also store in a system memory. Also, at 1030, during rendering, the compiler may utilize a loading or “ldg” function to read back position data. At 1040, the GPU may utilize a conditional store of position data into the GMEM. At 1042, the compiler may check a VS heavy draw to determine if a VS execution cycle is greater than N cycles and/or check if there is a heavy latency like texture fetch in VS. For instance, at 1042, during a VS heavy draw, if the VS execution cycle>N (e.g., N=200 or N=1000) cycles, aspects presented herein may utilize a conditional store position into memory (e.g., GMEM). Also, at 1042, if there is a heavy latency or texture fetch at the VS, aspects presented herein may utilize a conditional store position into memory (e.g., GMEM). At 1044, the driver may detect a drawcall size. Additionally, at 1050, a GPU may utilize a hardware solution. At 1060, during binning, the GPU hardware may store the position data into GMEM. At 1062, the storage may occur before or after a z test (e.g., a depth test). Also, at 1070, during rendering, the GPU hardware may read back position data from the GMEM. Thus, by reading back position data that was stored previously (e.g., during the binning stage), the GPU may avoid duplicate or multiple calculations of position data that occurred during the binning stage. Accordingly, this may allow the GPU to avoid multiple calculations of the position data and optimize the processing and/or power utilization at the GPU.

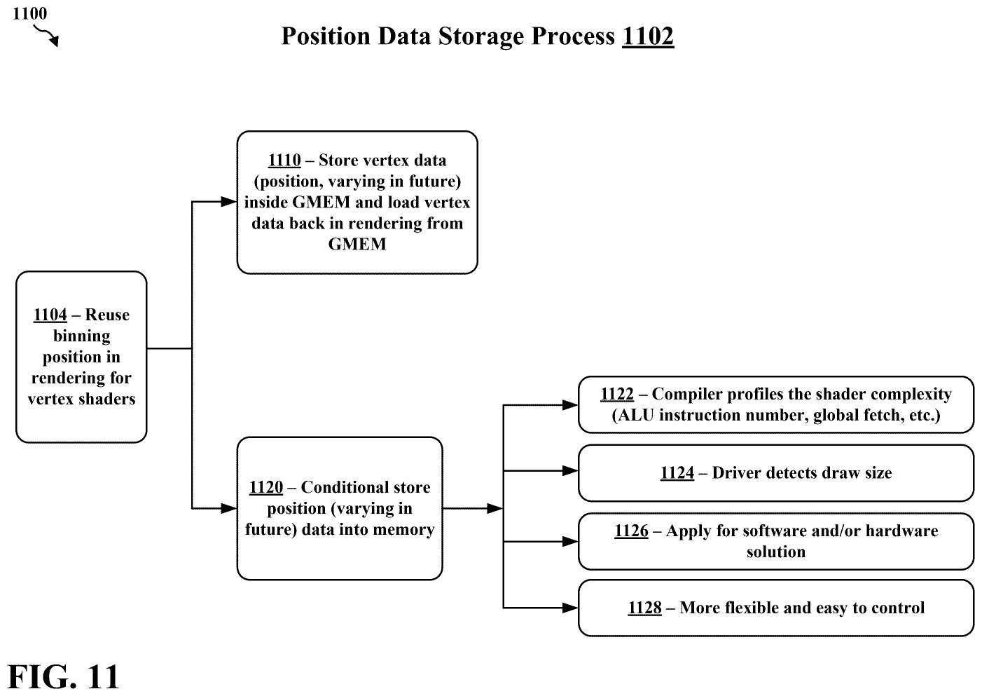

FIG. 11 illustrates diagram 1100 including one example of a position data storage process. More specifically, diagram 1100 depicts position data storage process 1102 for binning and/or rendering. As shown in FIG. 11, at 1104, similar to FIG. 10, a GPU may reuse a binning position in rendering for vertex shaders. At 1110, a GPU may store vertex data (e.g., position data and/or a storage of data that varies in the future) inside of a GMEM. Also, at 1110, a GPU may load vertex data back during rendering. This vertex data may be loaded from a GMEM. As indicated above, by loading back position data that was stored previously (e.g., during the binning stage), the GPU may avoid duplicate or multiple calculations of position data that occurred during the binning stage. At 1120, a GPU may utilize a conditional storage (a storage that varies in the future) of position data into memory (e.g., GMEM). At 1122, a compiler may profile the shader complexity (e.g., an ALU instruction number, global fetch, etc.). At 1124, a driver may detect a draw size. At 1126, the GPU may apply for the software solution and/or the hardware solution (e.g., the software solution and/or the hardware solution in FIG. 10). At 1128, the GPU may utilize storage of position data that is more flexible and easy to control. As shown in FIG. 11, by reading back position data that was stored previously (e.g., during the binning stage), the GPU may avoid duplicate or multiple calculations of position data that occurred during the binning stage. Therefore, this may allow the GPU to avoid multiple calculations of the position data and optimize the processing and/or power utilization at the GPU.

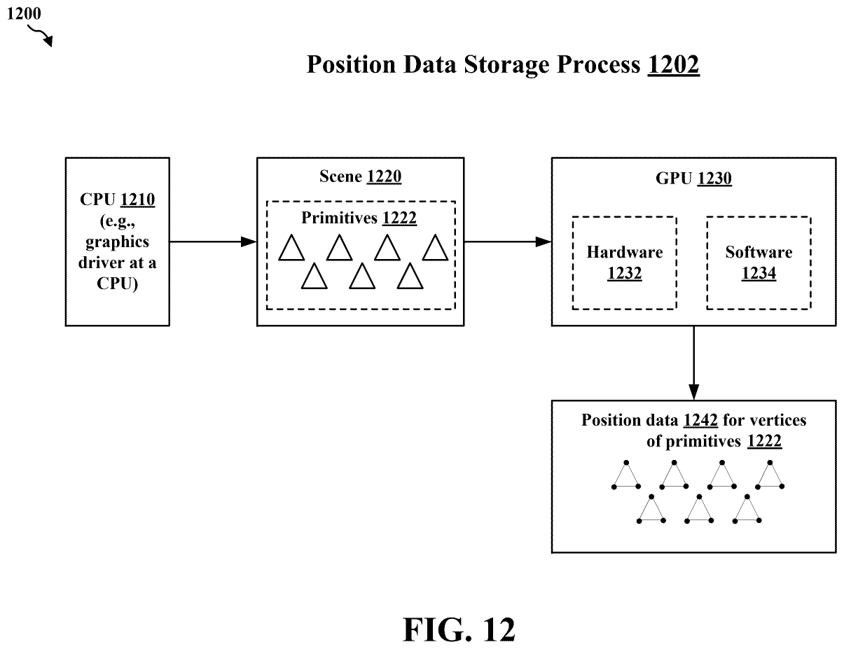

FIG. 12 illustrates diagram 1200 including one example of a position data storage process. More specifically, diagram 1200 depicts position data storage process 1202 at GPU 1230. As shown in FIG. 12, CPU 1210 may send GPU 1230 an indication of a scene 1220 (e.g., an image or frame) including a plurality of primitives 1222. For instance, GPU 1230 may obtain, from a CPU, an indication of scene 1220 including a plurality of primitives 1222. GPU 1230 may determine position data 1242 for each vertex in the set of vertices for each of the plurality of primitives 1222. In order to do so, GPU 1230 may utilize hardware 1232 and/or software 1234. The GPU 1230 may store, or refrain from storing, the position data 1242 for each vertex in the set of vertices for each of the plurality of primitives 1222 based on an execution cycle associated with the position data 1242. Based on the storage of the position data 1242 for each vertex, GPU 1230 may load the position data 1242 for each vertex in the set of vertices for each of the plurality of primitives 1222. By loading the position data that was stored previously (e.g., during the binning stage), the GPU 1230 may avoid duplicate or multiple calculations of position data 1242 that occurred previously (e.g., during the binning stage). Therefore, this may allow the GPU 1230 to avoid multiple calculations of the position data 1242 and optimize the processing and/or power utilization at the GPU 1230. The GPU 1230 may then perform (e.g., during a rendering stage at a vertex shader) a shading process based on the loaded position data 1242 for each vertex in the set of vertices for each of the plurality of primitives (e.g., the plurality of primitives 1222).

Aspects of the present disclosure may include a number of benefits or advantages. For instance, aspects of the present disclosure may avoid multiple calculations of position data. That is, aspects presented herein may reduce the amount of calculation operations during a rendering operation or a shading operation. For example, aspects presented herein may reduce the amount of calculation operations for position data during a rendering operation or a shading operation. For instance, aspects presented herein may avoid unnecessary calculations of position data during a rendering operation or a shading operation for a scene. Indeed, aspects presented herein may reduce the amount of processing performed at a GPU during rendering operations or shading operations. Also, aspects presented herein may reduce the amount of processing performed at a GPU when calculating position data for rendering operations or shading operations. Aspects presented herein may also reduce the amount of power utilized at the GPU during rendering operations or shading operations. Further, aspects presented herein may reduce the amount of power utilized at a GPU when calculating position data for rendering operations or shading operations. Based on this, aspects presented herein may optimized the processing and/or power utilization at a GPU.

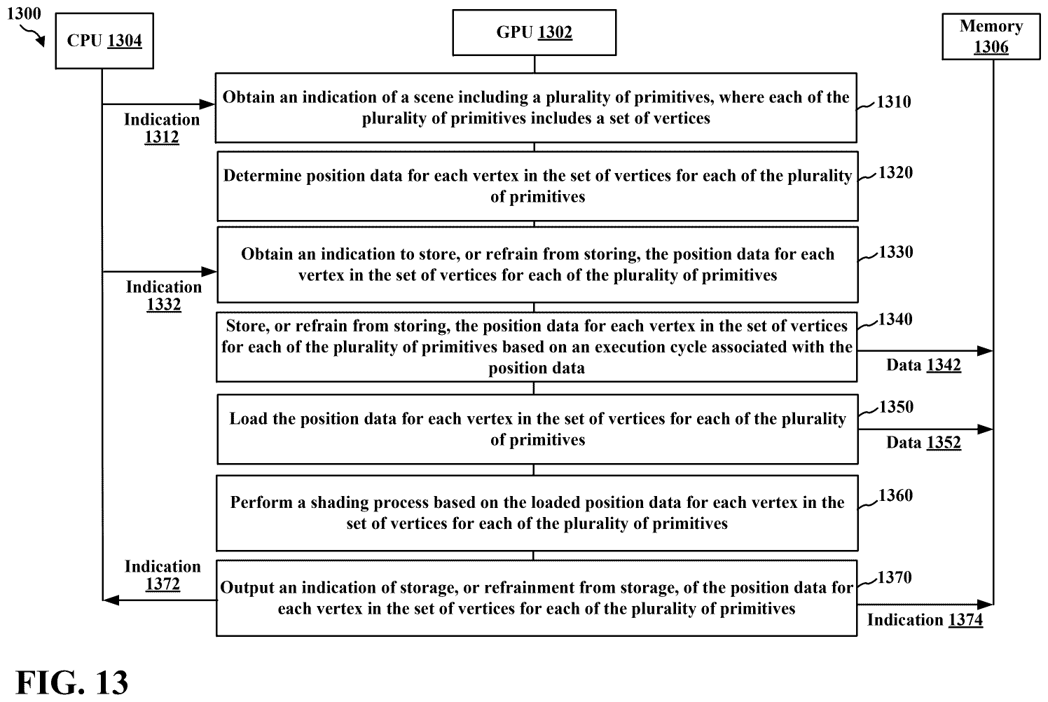

FIG. 13 is a communication flow diagram 1300 of graphics processing in accordance with one or more techniques of this disclosure. As shown in FIG. 13, diagram 1300 includes example communications between GPU 1302 (e.g., a GPU, a GPU component, another graphics processor, a CPU, a CPU component, or another central processor), CPU 1304 (e.g., a CPU, a graphics driver, a CPU component, or another central processor), and memory 1306 (e.g., a memory, a cache, a system memory, a graphics memory, a memory or cache at a CPU, or a memory or cache at a GPU), in accordance with one or more techniques of this disclosure.

At 1310, GPU 1302 may obtain an indication of a scene including a plurality of primitives, where each of the plurality of primitives includes a set of vertices. For example, GPU 1302 may receive indication 1312 from CPU 1304. In some aspects, the scene may be associated with a set of draw calls, and where each of the plurality of primitives may correspond to one draw call in the set of draw calls. Additionally, obtaining the indication of the scene including the plurality of primitives may comprise: obtaining, from a graphics driver, the indication of the scene including the plurality of primitives, where each draw call in the set of draw calls includes a draw call size.

At 1320, GPU 1302 may determine position data for each vertex in the set of vertices for each of the plurality of primitives. In some aspects, determining the position data for each vertex in the set of vertices for each of the plurality of primitives may comprise: calculating the position data for each vertex in the set of vertices for each of the plurality of primitives. Also, calculating the position data for each vertex in the set of vertices for each of the plurality of primitives may comprise: calculating, during a binning stage, the position data for each vertex in the set of vertices for each of the plurality of primitives. Further, calculating, during the binning stage, the position data for each vertex in the set of vertices for each of the plurality of primitives may comprise: calculating, during the binning stage at a vertex shader of a graphics processing unit (GPU), the position data for each vertex in the set of vertices for each of the plurality of primitives.

At 1330, GPU 1302 may obtain an indication to store, or refrain from storing, the position data for each vertex in the set of vertices for each of the plurality of primitives. For example, GPU 1302 may receive indication 1332 from CPU 1304. In some aspects, obtaining the indication to store, or refrain from storing, the position data for each vertex in the set of vertices for each of the plurality of primitives may comprise: obtaining, from a compiler, code for the indication to store, or refrain from storing, the position data for each vertex in the set of vertices for each of the plurality of primitives. Also, obtaining the indication to store the position data for each vertex in the set of vertices for each of the plurality of primitives may comprise: obtaining an indication of a memory address for storing the position data for each vertex in the set of vertices for each of the plurality of primitives.

At 1340, GPU 1302 may store, or refrain from storing, the position data for each vertex in the set of vertices for each of the plurality of primitives based on an execution cycle associated with the position data. For example, GPU 1302 may store data 1342 in memory 1306. In some aspects, storing, or refraining from storing, the position data for each vertex in the set of vertices for each of the plurality of primitives may comprise: storing, based on the execution cycle associated with the position data being less than a threshold, the position data for each vertex in the set of vertices for each of the plurality of primitives. Also, the threshold may be associated with at least one of a time or a power for a storage and a load of the execution cycle associated with the position data. In some aspects, storing, or refraining from storing, the position data for each vertex in the set of vertices for each of the plurality of primitives may comprise: refraining from storing, based on the execution cycle associated with the position data being greater than a threshold, the position data for each vertex in the set of vertices for each of the plurality of primitives. Additionally, storing the position data for each vertex in the set of vertices for each of the plurality of primitives may comprise: storing, in a memory at a graphics processing unit (GPU), the position data for each vertex in the set of vertices for each of the plurality of primitives. Further, storing, in the memory at the GPU, the position data for each vertex in the set of vertices for each of the plurality of primitives may comprise: storing, at a graphics memory (GMEM) or a system memory at the GPU, the position data for each vertex in the set of vertices for each of the plurality of primitives. In some aspects, storing, in the memory at the GPU, the position data for each vertex in the set of vertices for each of the plurality of primitives may comprise: storing, before or after a depth test at the GPU, the position data for each vertex in the set of vertices for each of the plurality of primitives.

At 1350, GPU 1302 may load, based on storage of the position data for each vertex, the position data for each vertex in the set of vertices for each of the plurality of primitives. For example, GPU 1302 may load data 1352 in memory 1306.

At 1360, GPU 1302 may perform a shading process based on the loaded position data for each vertex in the set of vertices for each of the plurality of primitives. In some aspects, performing the shading process based on the loaded position data may comprise: performing, during a rendering stage, the shading process based on the loaded position data. Also, performing, during the rendering stage, the shading process based on the loaded position data may comprise: performing, during the rendering stage at a vertex shader of a graphics processing unit (GPU), the shading process based on the loaded position data.

At 1370, GPU 1302 may output an indication of storage, or refrainment from storage, of the position data for each vertex in the set of vertices for each of the plurality of primitives. In some aspects, outputting the indication of the storage, or the refrainment from storage, of the position data for each vertex in the set of vertices for each of the plurality of primitives may comprise: transmitting the indication of the storage, or the refrainment from storage, of the position data for each vertex in the set of vertices for each of the plurality of primitives. For example, GPU 1302 may transmit indication 1372 to CPU 1304. Also, outputting the indication of the storage, or the refrainment from storage, of the position data for each vertex in the set of vertices for each of the plurality of primitives may comprise: storing the indication of the storage, or the refrainment from storage, of the position data for each vertex in the set of vertices for each of the plurality of primitives. For example, GPU 1302 may store indication 1374 in memory 1306.

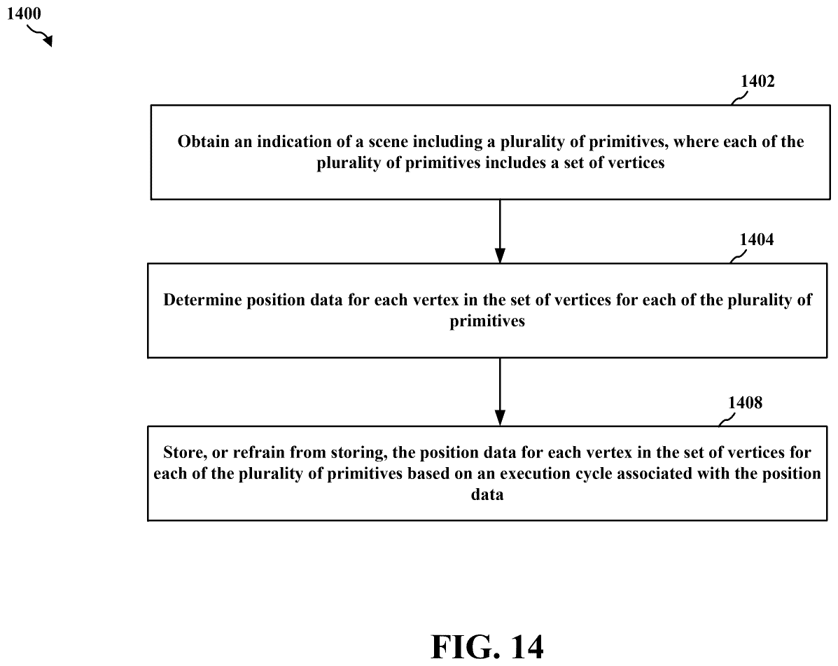

FIG. 14 is a flowchart 1400 of an example method of graphics processing in accordance with one or more techniques of this disclosure. The method may be performed by a GPU (e.g., a GPU, a GPU component, another graphics processor, a CPU, a CPU component, or another central processor), a CPU (e.g., a CPU, a graphics driver, a cache at a CPU, a CPU component, another central processor, a GPU, a GPU component, or another graphics processor), a graphics driver, a display driver integrated circuit (DDIC), an apparatus for graphics processing, a wireless communication device, and/or any apparatus that may perform graphics processing as used in connection with the examples of FIGS. 1-13.

At 1402, the GPU may obtain an indication of a scene including a plurality of primitives, where each of the plurality of primitives includes a set of vertices, as described in connection with the examples in FIGS. 1-13. For example, as described in 1310 of FIG. 13, GPU 1302 may obtain an indication of a scene including a plurality of primitives, where each of the plurality of primitives includes a set of vertices. Further, step 1402 may be performed by processing unit 120 in FIG. 1. For example, GPU 1302 may receive indication 1312 from CPU 1304. In some aspects, the scene may be associated with a set of draw calls, and where each of the plurality of primitives may correspond to one draw call in the set of draw calls. Additionally, obtaining the indication of the scene including the plurality of primitives may comprise: obtaining, from a graphics driver, the indication of the scene including the plurality of primitives, where each draw call in the set of draw calls includes a draw call size.

At 1404, the GPU may determine position data for each vertex in the set of vertices for each of the plurality of primitives, as described in connection with the examples in FIGS. 1-13. For example, as described in 1320 of FIG. 13, GPU 1302 may determine position data for each vertex in the set of vertices for each of the plurality of primitives. Further, step 1404 may be performed by processing unit 120 in FIG. 1. In some aspects, determining the position data for each vertex in the set of vertices for each of the plurality of primitives may comprise: calculating the position data for each vertex in the set of vertices for each of the plurality of primitives. Also, calculating the position data for each vertex in the set of vertices for each of the plurality of primitives may comprise: calculating, during a binning stage, the position data for each vertex in the set of vertices for each of the plurality of primitives. Further, calculating, during the binning stage, the position data for each vertex in the set of vertices for each of the plurality of primitives may comprise: calculating, during the binning stage at a vertex shader of a graphics processing unit (GPU), the position data for each vertex in the set of vertices for each of the plurality of primitives.

At 1408, the GPU may store, or refrain from storing, the position data for each vertex in the set of vertices for each of the plurality of primitives based on an execution cycle associated with the position data, as described in connection with the examples in FIGS. 1-13. For example, as described in 1340 of FIG. 13, GPU 1302 may store, or refrain from storing, the position data for each vertex in the set of vertices for each of the plurality of primitives based on an execution cycle associated with the position data. Further, step 1408 may be performed by processing unit 120 in FIG. 1. For example, GPU 1302 may store data 1342 in memory 1306. In some aspects, storing, or refraining from storing, the position data for each vertex in the set of vertices for each of the plurality of primitives may comprise: storing, based on the execution cycle associated with the position data being less than a threshold, the position data for each vertex in the set of vertices for each of the plurality of primitives. Also, the threshold may be associated with at least one of a time or a power for a storage and a load of the execution cycle associated with the position data. In some aspects, storing, or refraining from storing, the position data for each vertex in the set of vertices for each of the plurality of primitives may comprise: refraining from storing, based on the execution cycle associated with the position data being greater than a threshold, the position data for each vertex in the set of vertices for each of the plurality of primitives. Additionally, storing the position data for each vertex in the set of vertices for each of the plurality of primitives may comprise: storing, in a memory at a graphics processing unit (GPU), the position data for each vertex in the set of vertices for each of the plurality of primitives. Further, storing, in the memory at the GPU, the position data for each vertex in the set of vertices for each of the plurality of primitives may comprise: storing, at a graphics memory (GMEM) or a system memory at the GPU, the position data for each vertex in the set of vertices for each of the plurality of primitives. In some aspects, storing, in the memory at the GPU, the position data for each vertex in the set of vertices for each of the plurality of primitives may comprise: storing, before or after a depth test at the GPU, the position data for each vertex in the set of vertices for each of the plurality of primitives.

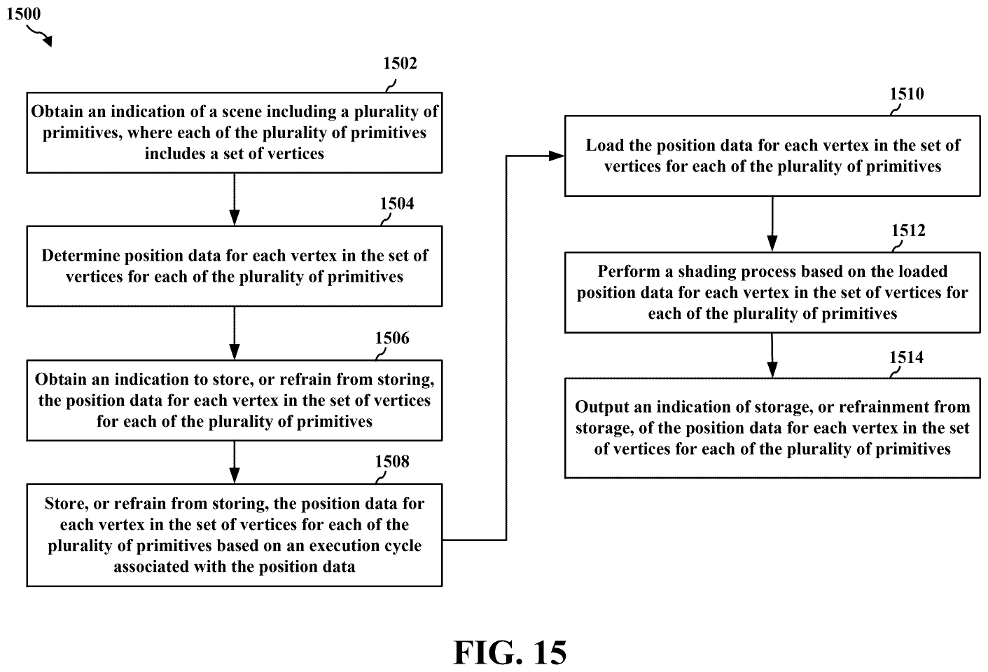

FIG. 15 is a flowchart 1500 of an example method of graphics processing in accordance with one or more techniques of this disclosure. The method may be performed by a GPU (e.g., a GPU, a GPU component, another graphics processor, a CPU, a CPU component, or another central processor), a CPU (e.g., a CPU, a graphics driver, a cache at a CPU, a CPU component, another central processor, a GPU, a GPU component, or another graphics processor), a graphics driver, a display driver integrated circuit (DDIC), an apparatus for graphics processing, a wireless communication device, and/or any apparatus that may perform graphics processing as used in connection with the examples of FIGS. 1-13.

At 1502, the GPU may obtain an indication of a scene including a plurality of primitives, where each of the plurality of primitives includes a set of vertices, as described in connection with the examples in FIGS. 1-13. For example, as described in 1310 of FIG. 13, GPU 1302 may obtain an indication of a scene including a plurality of primitives, where each of the plurality of primitives includes a set of vertices. Further, step 1502 may be performed by processing unit 120 in FIG. 1. For example, GPU 1302 may receive indication 1312 from CPU 1304. In some aspects, the scene may be associated with a set of draw calls, and where each of the plurality of primitives may correspond to one draw call in the set of draw calls. Additionally, obtaining the indication of the scene including the plurality of primitives may comprise: obtaining, from a graphics driver, the indication of the scene including the plurality of primitives, where each draw call in the set of draw calls includes a draw call size.

At 1504, the GPU may determine position data for each vertex in the set of vertices for each of the plurality of primitives, as described in connection with the examples in FIGS. 1-13. For example, as described in 1320 of FIG. 13, GPU 1302 may determine position data for each vertex in the set of vertices for each of the plurality of primitives. Further, step 1504 may be performed by processing unit 120 in FIG. 1. In some aspects, determining the position data for each vertex in the set of vertices for each of the plurality of primitives may comprise: calculating the position data for each vertex in the set of vertices for each of the plurality of primitives. Also, calculating the position data for each vertex in the set of vertices for each of the plurality of primitives may comprise: calculating, during a binning stage, the position data for each vertex in the set of vertices for each of the plurality of primitives. Further, calculating, during the binning stage, the position data for each vertex in the set of vertices for each of the plurality of primitives may comprise: calculating, during the binning stage at a vertex shader of a graphics processing unit (GPU), the position data for each vertex in the set of vertices for each of the plurality of primitives.

At 1506, the GPU may obtain an indication to store, or refrain from storing, the position data for each vertex in the set of vertices for each of the plurality of primitives, as described in connection with the examples in FIGS. 1-13. For example, as described in 1330 of FIG. 13, GPU 1302 may obtain an indication to store, or refrain from storing, the position data for each vertex in the set of vertices for each of the plurality of primitives. Further, step 1506 may be performed by processing unit 120 in FIG. 1. For example, GPU 1302 may receive indication 1332 from CPU 1304. In some aspects, obtaining the indication to store, or refrain from storing, the position data for each vertex in the set of vertices for each of the plurality of primitives may comprise: obtaining, from a compiler, code for the indication to store, or refrain from storing, the position data for each vertex in the set of vertices for each of the plurality of primitives. Also, obtaining the indication to store the position data for each vertex in the set of vertices for each of the plurality of primitives may comprise: obtaining an indication of a memory address for storing the position data for each vertex in the set of vertices for each of the plurality of primitives.

At 1508, the GPU may store, or refrain from storing, the position data for each vertex in the set of vertices for each of the plurality of primitives based on an execution cycle associated with the position data, as described in connection with the examples in FIGS. 1-13. For example, as described in 1340 of FIG. 13, GPU 1302 may store, or refrain from storing, the position data for each vertex in the set of vertices for each of the plurality of primitives based on an execution cycle associated with the position data. Further, step 1508 may be performed by processing unit 120 in FIG. 1. For example, GPU 1302 may store data 1342 in memory 1306. In some aspects, storing, or refraining from storing, the position data for each vertex in the set of vertices for each of the plurality of primitives may comprise: storing, based on the execution cycle associated with the position data being less than a threshold, the position data for each vertex in the set of vertices for each of the plurality of primitives. Also, the threshold may be associated with at least one of a time or a power for a storage and a load of the execution cycle associated with the position data. In some aspects, storing, or refraining from storing, the position data for each vertex in the set of vertices for each of the plurality of primitives may comprise: refraining from storing, based on the execution cycle associated with the position data being greater than a threshold, the position data for each vertex in the set of vertices for each of the plurality of primitives. Additionally, storing the position data for each vertex in the set of vertices for each of the plurality of primitives may comprise: storing, in a memory at a graphics processing unit (GPU), the position data for each vertex in the set of vertices for each of the plurality of primitives. Further, storing, in the memory at the GPU, the position data for each vertex in the set of vertices for each of the plurality of primitives may comprise: storing, at a graphics memory (GMEM) or a system memory at the GPU, the position data for each vertex in the set of vertices for each of the plurality of primitives. In some aspects, storing, in the memory at the GPU, the position data for each vertex in the set of vertices for each of the plurality of primitives may comprise: storing, before or after a depth test at the GPU, the position data for each vertex in the set of vertices for each of the plurality of primitives.

At 1510, the GPU may load, based on storage of the position data for each vertex, the position data for each vertex in the set of vertices for each of the plurality of primitives, as described in connection with the examples in FIGS. 1-13. For example, as described in 1350 of FIG. 13, GPU 1302 may load, based on storage of the position data for each vertex, the position data for each vertex in the set of vertices for each of the plurality of primitives. Further, step 1510 may be performed by processing unit 120 in FIG. 1. For example, GPU 1302 may load data 1352 in memory 1306.

At 1512, the GPU may perform a shading process based on the loaded position data for each vertex in the set of vertices for each of the plurality of primitives, as described in connection with the examples in FIGS. 1-13. For example, as described in 1360 of FIG. 13, GPU 1302 may perform a shading process based on the loaded position data for each vertex in the set of vertices for each of the plurality of primitives. Further, step 1512 may be performed by processing unit 120 in FIG. 1. In some aspects, performing the shading process based on the loaded position data may comprise: performing, during a rendering stage, the shading process based on the loaded position data. Also, performing, during the rendering stage, the shading process based on the loaded position data may comprise: performing, during the rendering stage at a vertex shader of a graphics processing unit (GPU), the shading process based on the loaded position data.

At 1514, the GPU may output an indication of storage, or refrainment from storage, of the position data for each vertex in the set of vertices for each of the plurality of primitives, as described in connection with the examples in FIGS. 1-13. For example, as described in 1370 of FIG. 13, GPU 1302 may output an indication of storage, or refrainment from storage, of the position data for each vertex in the set of vertices for each of the plurality of primitives. Further, step 1514 may be performed by processing unit 120 in FIG. 1. In some aspects, outputting the indication of the storage, or the refrainment from storage, of the position data for each vertex in the set of vertices for each of the plurality of primitives may comprise: transmitting the indication of the storage, or the refrainment from storage, of the position data for each vertex in the set of vertices for each of the plurality of primitives. For example, GPU 1302 may transmit indication 1372 to CPU 1304. Also, outputting the indication of the storage, or the refrainment from storage, of the position data for each vertex in the set of vertices for each of the plurality of primitives may comprise: storing the indication of the storage, or the refrainment from storage, of the position data for each vertex in the set of vertices for each of the plurality of primitives. For example, GPU 1302 may store indication 1374 in memory 1306.

In configurations, a method or an apparatus for graphics processing is provided. The apparatus may be a GPU (or other graphics processor), a CPU (or other central processor), a graphics driver, a DDIC, an apparatus for graphics processing, and/or some other processor that may perform data or graphics processing. In aspects, the apparatus may be the processing unit 120 within the device 104, or may be some other hardware within the device 104 or another device. The apparatus, e.g., processing unit 120, may include means for obtaining an indication of a scene including a plurality of primitives, where each of the plurality of primitives includes a set of vertices. The apparatus, e.g., processing unit 120, may also include means for determining position data for each vertex in the set of vertices for each of the plurality of primitives. The apparatus, e.g., processing unit 120, may also include means for storing, or refraining from storing, the position data for each vertex in the set of vertices for each of the plurality of primitives based on an execution cycle associated with the position data. The apparatus, e.g., processing unit 120, may also include means for loading, based on storage of the position data for each vertex, the position data for each vertex in the set of vertices for each of the plurality of primitives. The apparatus, e.g., processing unit 120, may also include means for performing a shading process based on the loaded position data for each vertex in the set of vertices for each of the plurality of primitives. The apparatus, e.g., processing unit 120, may also include means for obtaining an indication to store, or refrain from storing, the position data for each vertex in the set of vertices for each of the plurality of primitives. The apparatus, e.g., processing unit 120, may also include means for outputting an indication of storage, or refrainment from storage, of the position data for each vertex in the set of vertices for each of the plurality of primitives.

The subject matter described herein may be implemented to realize one or more benefits or advantages. For instance, the described graphics processing techniques may be used by a GPU, a CPU, a central processor, or some other processor that may perform graphics processing to implement the position data storage techniques described herein. This may also be accomplished at a low cost compared to other graphics processing techniques. Moreover, the graphics processing techniques herein may improve or speed up graphics processing or execution. Further, the graphics processing techniques herein may improve resource or data utilization and/or resource efficiency. Additionally, aspects of the present disclosure may utilize position data storage techniques in order to improve memory bandwidth efficiency and/or increase processing speed at a GPU, a CPU, or a DPU.

It is understood that the specific order or hierarchy of blocks in the processes / flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including at least one memory and at least one processor coupled to the at least one memory and, based at least in part on information stored in the at least one memory, the at least one processor, individually or in any combination, is configured to: obtain an indication of a scene including a plurality of primitives, wherein each of the plurality of primitives includes a set of vertices; determine position data for each vertex in the set of vertices for each of the plurality of primitives; and store, or refrain from storing, the position data for each vertex in the set of vertices for each of the plurality of primitives based on an execution cycle associated with the position data.

Aspect 2 is the apparatus of aspect 1, wherein to store, or refrain from storing, the position data for each vertex in the set of vertices for each of the plurality of primitives, the at least one processor, individually or in any combination, is configured to: store, based on the execution cycle associated with the position data being less than a threshold, the position data for each vertex in the set of vertices for each of the plurality of primitives.

Aspect 3 is the apparatus of aspect 2, wherein the threshold is associated with at least one of a time or a power for a storage and a load of the execution cycle associated with the position data.

Aspect 4 is the apparatus of any of aspects 1 to 3, wherein to store, or refrain from storing, the position data for each vertex in the set of vertices for each of the plurality of primitives, the at least one processor, individually or in any combination, is configured to: refrain from storing, based on the execution cycle associated with the position data being greater than a threshold, the position data for each vertex in the set of vertices for each of the plurality of primitives.

Aspect 5 is the apparatus of any of aspects 1 to 4, wherein to store the position data for each vertex in the set of vertices for each of the plurality of primitives, the at least one processor, individually or in any combination, is configured to: store, in a memory at a graphics processing unit (GPU), the position data for each vertex in the set of vertices for each of the plurality of primitives.

Aspect 6 is the apparatus of aspect 5, wherein to store, in the memory at the GPU, the position data for each vertex in the set of vertices for each of the plurality of primitives, the at least one processor, individually or in any combination, is configured to: store, at a graphics memory (GMEM) or a system memory at the GPU, the position data for each vertex in the set of vertices for each of the plurality of primitives.

Aspect 7 is the apparatus of any of aspects 5 to 6, wherein to store, in the memory at the GPU, the position data for each vertex in the set of vertices for each of the plurality of primitives, the at least one processor, individually or in any combination, is configured to: store, before or after a depth test at the GPU, the position data for each vertex in the set of vertices for each of the plurality of primitives.

Aspect 8 is the apparatus of any of aspects 1 to 7, wherein the at least one processor, individually or in any combination, is further configured to: load, based on storage of the position data for each vertex, the position data for each vertex in the set of vertices for each of the plurality of primitives.

Aspect 9 is the apparatus of aspect 8, wherein the at least one processor, individually or in any combination, is further configured to: perform a shading process based on the loaded position data for each vertex in the set of vertices for each of the plurality of primitives.

Aspect 10 is the apparatus of aspect 9, wherein to perform the shading process based on the loaded position data, the at least one processor, individually or in any combination, is configured to: perform, during a rendering stage, the shading process based on the loaded position data.

Aspect 11 is the apparatus of aspect 10, wherein to perform, during the rendering stage, the shading process based on the loaded position data, the at least one processor, individually or in any combination, is configured to: perform, during the rendering stage at a vertex shader of a graphics processing unit (GPU), the shading process based on the loaded position data.

Aspect 12 is the apparatus of any of aspects 1 to 11, wherein the at least one processor, individually or in any combination, is further configured to: obtain an indication to store, or refrain from storing, the position data for each vertex in the set of vertices for each of the plurality of primitives.

Aspect 13 is the apparatus of aspect 12, wherein to obtain the indication to store, or refrain from storing, the position data for each vertex in the set of vertices for each of the plurality of primitives, the at least one processor, individually or in any combination, is configured to: obtain, from a compiler, code for the indication to store, or refrain from storing, the position data for each vertex in the set of vertices for each of the plurality of primitives.

Aspect 14 is the apparatus of any of aspects 12 to 13, wherein to obtain the indication to store the position data for each vertex in the set of vertices for each of the plurality of primitives, the at least one processor, individually or in any combination, is configured to: obtain an indication of a memory address for storing the position data for each vertex in the set of vertices for each of the plurality of primitives.

Aspect 15 is the apparatus of any of aspects 1 to 14, wherein to determine the position data for each vertex in the set of vertices for each of the plurality of primitives, the at least one processor, individually or in any combination, is configured to: calculate the position data for each vertex in the set of vertices for each of the plurality of primitives.

Aspect 16 is the apparatus of aspect 15, wherein to calculate the position data for each vertex in the set of vertices for each of the plurality of primitives, the at least one processor, individually or in any combination, is configured to: calculate, during a binning stage, the position data for each vertex in the set of vertices for each of the plurality of primitives.

Aspect 17 is the apparatus of aspect 16, wherein to calculate, during the binning stage, the position data for each vertex in the set of vertices for each of the plurality of primitives, the at least one processor, individually or in any combination, is configured to: calculate, during the binning stage at a vertex shader of a graphics processing unit (GPU), the position data for each vertex in the set of vertices for each of the plurality of primitives.

Aspect 18 is the apparatus of any of aspects 1 to 17, wherein the scene is associated with a set of draw calls, and wherein each of the plurality of primitives correspond to one draw call in the set of draw calls.

Aspect 19 is the apparatus of aspect 18, wherein to obtain the indication of the scene including the plurality of primitives, the at least one processor, individually or in any combination, is configured to: obtain, from a graphics driver, the indication of the scene including the plurality of primitives, wherein each draw call in the set of draw calls includes a draw call size.

Aspect 20 is the apparatus of any of aspects 1 to 19, wherein the at least one processor, individually or in any combination, is further configured to: output an indication of storage, or refrainment from storage, of the position data for each vertex in the set of vertices for each of the plurality of primitives.

Aspect 21 is the apparatus of aspect 20, wherein to output the indication of the storage, or the refrainment from storage, of the position data for each vertex in the set of vertices for each of the plurality of primitives, the at least one processor, individually or in any combination, is configured to: transmit the indication of the storage, or the refrainment from storage, of the position data for each vertex in the set of vertices for each of the plurality of primitives; or store the indication of the storage, or the refrainment from storage, of the position data for each vertex in the set of vertices for each of the plurality of primitives.

Aspect 22 is the apparatus of aspect 21, further including (i.e., comprising) at least one of an antenna or a transceiver coupled to the at least one processor, wherein to transmit the indication of the storage, or the refrainment from storage, of the position data for each vertex in the set of vertices for each of the plurality of primitives, the at least one processor, individually or in any combination, is configured to: transmit, via at least one of the antenna or the transceiver, the indication of the storage, or the refrainment from storage, of the position data for each vertex in the set of vertices for each of the plurality of primitives.

Aspect 23 is the apparatus of any of aspects 1 to 22, wherein the apparatus is a wireless communication device.

Aspect 24 is a method of graphics processing for implementing any of aspects 1 to 23.

Aspect 25 is an apparatus for graphics processing including means for implementing any of aspects 1 to 23.

Aspect 26 is a computer-readable medium (e.g., a non-transitory computer-readable medium) storing computer executable code (e.g., code for graphics processing), the code when executed by at least one processor causes the at least one processor to implement any of aspects 1 to 23.

What is claimed is:

1. An apparatus for graphics processing, comprising:
at least one memory; and
at least one processor coupled to the at least one memory and, based at least in part on information stored in the at least one memory, the at least one processor, individually or in any combination, is configured to:
obtain an indication of a scene including a plurality of primitives, wherein each of the plurality of primitives includes a set of vertices;
determine position data for each vertex in the set of vertices for each of the plurality of primitives; and
store, or refrain from storing, the position data for each vertex in the set of vertices for each of the plurality of primitives based on an execution cycle associated with the position data.

2. The apparatus of claim 1, wherein to store, or refrain from storing, the position data for each vertex in the set of vertices for each of the plurality of primitives, the at least one processor, individually or in any combination, is configured to:
store, based on the execution cycle associated with the position data being less than a threshold, the position data for each vertex in the set of vertices for each of the plurality of primitives.

3. The apparatus of claim 2, wherein the threshold is associated with at least one of a time or a power for a storage and a load of the execution cycle associated with the position data.

4. The apparatus of claim 1, wherein to store, or refrain from storing, the position data for each vertex in the set of vertices for each of the plurality of primitives, the at least one processor, individually or in any combination, is configured to:
refrain from storing, based on the execution cycle associated with the position data being greater than a threshold, the position data for each vertex in the set of vertices for each of the plurality of primitives.

5. The apparatus of claim 1, wherein to store the position data for each vertex in the set of vertices for each of the plurality of primitives, the at least one processor, individually or in any combination, is configured to:
store, in a memory at a graphics processing unit (GPU), the position data for each vertex in the set of vertices for each of the plurality of primitives.

6. The apparatus of claim 5, wherein to store, in the memory at the GPU, the position data for each vertex in the set of vertices for each of the plurality of primitives, the at least one processor, individually or in any combination, is configured to:
store, at a graphics memory (GMEM) or a system memory at the GPU, the position data for each vertex in the set of vertices for each of the plurality of primitives.

7. The apparatus of claim 5, wherein to store, in the memory at the GPU, the position data for each vertex in the set of vertices for each of the plurality of primitives, the at least one processor, individually or in any combination, is configured to:
store, before or after a depth test at the GPU, the position data for each vertex in the set of vertices for each of the plurality of primitives.

8. The apparatus of claim 1, wherein the at least one processor, individually or in any combination, is further configured to:
load, based on storage of the position data for each vertex, the position data for each vertex in the set of vertices for each of the plurality of primitives.

9. The apparatus of claim 8, wherein the at least one processor, individually or in any combination, is further configured to:
perform a shading process based on the loaded position data for each vertex in the set of vertices for each of the plurality of primitives.

10. The apparatus of claim 9, wherein to perform the shading process based on the loaded position data, the at least one processor, individually or in any combination, is configured to:
perform, during a rendering stage, the shading process based on the loaded position data.

11. The apparatus of claim 10, wherein to perform, during the rendering stage, the shading process based on the loaded position data, the at least one processor, individually or in any combination, is configured to:
perform, during the rendering stage at a vertex shader of a graphics processing unit (GPU), the shading process based on the loaded position data.

12. The apparatus of claim 1, wherein the at least one processor, individually or in any combination, is further configured to:
obtain an indication to store, or refrain from storing, the position data for each vertex in the set of vertices for each of the plurality of primitives.

13. The apparatus of claim 12, wherein to obtain the indication to store, or refrain from storing, the position data for each vertex in the set of vertices for each of the plurality of primitives, the at least one processor, individually or in any combination, is configured to:
obtain, from a compiler, code for the indication to store, or refrain from storing, the position data for each vertex in the set of vertices for each of the plurality of primitives.

14. The apparatus of claim 12, wherein to obtain the indication to store the position data for each vertex in the set of vertices for each of the plurality of primitives, the at least one processor, individually or in any combination, is configured to:
obtain an indication of a memory address for storing the position data for each vertex in the set of vertices for each of the plurality of primitives.

15. The apparatus of claim 1, wherein to determine the position data for each vertex in the set of vertices for each of the plurality of primitives, the at least one processor, individually or in any combination, is configured to:
calculate the position data for each vertex in the set of vertices for each of the plurality of primitives.

16. The apparatus of claim 15, wherein to calculate the position data for each vertex in the set of vertices for each of the plurality of primitives, the at least one processor, individually or in any combination, is configured to:
calculate, during a binning stage at a vertex shader of a graphics processing unit (GPU), the position data for each vertex in the set of vertices for each of the plurality of primitives.

17. The apparatus of claim 1, wherein the scene is associated with a set of draw calls, wherein each of the plurality of primitives correspond to one draw call in the set of draw calls, and wherein to obtain the indication of the scene including the plurality of primitives, the at least one processor, individually or in any combination, is configured to:
obtain, from a graphics driver, the indication of the scene including the plurality of primitives, wherein each draw call in the set of draw calls includes a draw call size.

18. The apparatus of claim 1, wherein the at least one processor, individually or in any combination, is further configured to:
output an indication of storage, or refrainment from storage, of the position data for each vertex in the set of vertices for each of the plurality of primitives.

19. A method of graphics processing, comprising:
obtaining an indication of a scene including a plurality of primitives, wherein each of the plurality of primitives includes a set of vertices;
determining position data for each vertex in the set of vertices for each of the plurality of primitives; and
storing, or refraining from storing, the position data for each vertex in the set of vertices for each of the plurality of primitives based on an execution cycle associated with the position data.

20. A computer-readable medium storing computer executable code for graphics processing, the code when executed by at least one processor causes the at least one processor to:
obtain an indication of a scene including a plurality of primitives, wherein each of the plurality of primitives includes a set of vertices;
determine position data for each vertex in the set of vertices for each of the plurality of primitives; and
store, or refrain from storing, the position data for each vertex in the set of vertices for each of the plurality of primitives based on an execution cycle associated with the position data.
